(19) United States
(12) Patent Application Publication
(10) Pub. No.: US 2010/0003510 A1
(43) Pub. Date: Jan. 7, 2010

(54) Corrosion-resistant multilayer ceramic member

(75) Inventors: Shoji Kano, Annaka (JP); Waichi Yamamura, Annaka (JP); Yoshihiro Kubota, Annaka (JP)

Correspondence Address: OLIFF & BERRIDGE, PLC, P.O. BOX 320850, ALEXANDRIA, VA, 22320-4850, US

(73) Assignee: SHIN-ETSU CHEMICAL CO., LTD., Tokyo (JP)

(21) Appl. No.: 12/457,781

(22) Filed: Jun. 22, 2009

(30) Foreign Application Priority Data
Jul. 7, 2008 (JP) 2008-177212

(51) Int. Cl. B32B 7/00

(52) U.S. Cl. 428/336; 428/332; 428/334; 428/335

(57) ABSTRACT

The present invention is a corrosion-resistant multilayer ceramic member including at least: a ceramic substrate, an electrode layer formed on the ceramic substrate, a feeding member that supplies electricity to the electrode layer, and a protection layer that prevents corrosion; wherein the electrode layer is formed on one surface or both surfaces of the ceramic substrate, the feeding member is connected with the electrode layer, the protection layer is formed with a thickness of 0.02 mm or above and 10 mm or less on that surface of the ceramic substrate where the electrode layer is formed so as to cover the electrode layer, and the protection layer contains any one of silicon oxide, rare-earth oxide, aluminum nitride, and aluminum oxide as a main component. Hereby, there is provided a corrosion-resistant multilayer ceramic member that has excellent corrosion resistance and a long life duration even when exposed to a corrosive gas.

### BACKGROUND OF THE INVENTION

1. Field of the Invention

The present invention relates to a ceramic member such as a ceramic heater, an electrostatic chuck, or a high-frequency electrode which can be preferably used in, e.g., a semiconductor wafer heating process in a manufacturing process or an inspection process for a semiconductor device.

2. Description of the Related Art

When fabricating a semiconductor device, a technology that forms, e.g., a polysilicon film, an oxide film, a conductor film, and a dielectric film on a semiconductor wafer by using a CVD apparatus or a sputtering apparatus or etches such thin films by using an etching apparatus is well known. Further, ceramic members each having an electrode, e.g., an electrostatic chuck, a heater, and a high-frequency electrode are mounted in these apparatuses in order to heat the semiconductor wafer in each process, e.g., formation or etching of the thin films.

As a ceramic heater, one obtained by using aluminum nitride substrate as a first ceramic substrate and integrating a conductor layer formed on this substrate and a second aluminum nitride substrate that covers this conductor layer by simultaneous firing has been suggested (Japanese Unexamined Patent Publication (Kokai) No. H3-236186). However, the ceramic heater having such a configuration has a high thermal conductivity to heat a heater surface with a uniform temperature distribution, but it has a problem of a short life duration since it is damaged when used at a high temperature or rapidly heated or cooled.

### SUMMARY OF THE INVENTION

Thus, as a ceramic heater having thermal shock resistance against, e.g., rapid heating or rapid cooling, one constituted of a ceramic substrate formed of aluminum nitride, a conductor layer formed on this substrate, and a sprayed film formed of alumina that is laminated to cover the conductor layer has been devised (Japanese Unexamined Patent Publication (Kokai) No. H6-157172).

However, in a semiconductor manufacturing apparatus, a corrosive gas such as a chlorinated gas or a fluorinated gas is used as a deposition gas, an etching gas, or a cleaning gas. The present inventors have revealed that, when a conventional multilayer ceramic heater or electrostatic chuck having an electrode whose surface is covered with the above-described material is used, a coating member is eroded in a short time due to exposure to such a gas, corrosion reaches the electrode, and the electrode is likewise eroded to lose its primary function.

To solve the above-described problem, it is an object of the present invention to provide a long-lived corrosion-resistant multilayer ceramic member that is superior in corrosion resistance even when exposed to a corrosive gas as described above.

To achieve this object, according to the present invention, there is provided a corrosion-resistant multilayer ceramic member including at least: a ceramic substrate, an electrode layer formed on the ceramic substrate, a feeding member that supplies electricity to the electrode layer, and a protection layer that prevents corrosion; wherein the electrode layer is formed on one surface or both surfaces of the ceramic substrate, the feeding member is connected with the electrode layer, the protection layer is formed with a thickness of 0.02 mm or above and 10 mm or less on that surface of the ceramic substrate where the electrode layer is formed so as to cover the electrode layer, and the protection layer contains any one of silicon oxide, rare-earth oxide, aluminum nitride, and aluminum oxide as a main component.

When there is provided the corrosion-resistant multilayer ceramic member including at least: a ceramic substrate, an electrode layer formed on the ceramic substrate, a feeding member that supplies electricity to the electrode layer, and a protection layer that prevents corrosion; wherein the electrode layer is formed on one surface or both surfaces of the ceramic substrate, the feeding member is connected with the electrode layer, the protection layer formed on that surface of the ceramic substrate where the electrode layer is formed so as to cover the electrode layer contains any one of silicon oxide, rare-earth oxide, aluminum nitride, and aluminum oxide as a main component and is formed with a thickness of 0.02 mm or above and 10 mm or less, corrosion resistance can be greatly improved, the electrode layer can be prevented from being wasted, and the protection layer can be prevented from being delaminated from the ceramic substrate due to thermal stress.

Further, in this case, it is preferable that the protection layer formed on that surface of the ceramic substrate where the electrode layer is formed is formed to entirely enclose a connecting portion of the ceramic substrate and the electrode layer and that of the electrode layer and the feeding member.

As described above, when there is provided the corrosion-resistant multilayer ceramic member in which the protection layer is formed to entirely enclose the connecting portion of the ceramic substrate and the electrode layer and that of the electrode layer and the feeding member, the corrosive gas can be prevented from entering from the connecting portion in particular, thereby greatly improving corrosion resistance.

Furthermore, it is preferable that the corrosion-resistant multilayer ceramic member is subjected to a heat treatment at a temperature of 1000° C. or above.

When the corrosion-resistant multilayer ceramic member is subjected to a heat treatment at a temperature of 1000° C. or above in this manner, contact of the protection layer and the electrode layer is improved, and the protection layer is densified, thereby realizing a longer life duration.

Moreover, it is preferable that the ceramic substrate is formed of a material including any one of aluminum nitride, rare-earth oxide, aluminum oxide, silicon oxide, zirconia, and sialon as a main component.

When the material of the ceramic substrate contains any one of aluminum nitride, rare-earth oxide, aluminum oxide, silicon oxide, zirconia, and sialon as a main component in this manner, the corrosion-resistant multilayer ceramic having further excellent corrosion resistance can be provided.

Additionally, it is preferable that the protection layer is formed by any technique selected from a screen printing method, a chemical vapor deposition method, and a plasma spraying method, and the electrode layer is formed by any technique selected from the screen printing method, the chemical vapor deposition method, and the spraying method.

When the protection layer is formed by any technique selected from the screen printing method, the chemical vapor deposition method, and the plasma spraying method and the electrode layer is formed by any technique selected from the screen printing method, the chemical vapor deposition method, and the spraying method as described above, the protection layer and the electrode layer that have excellent uniformity can be provided. Further, since the protection layer and the electrode layer having excellent uniformity can be easily formed, the corrosion-resistant multilayer ceramic member having a high yield ratio can be obtained.

According to the present invention, the electrode layer is formed on the ceramic substrate, the protection layer that prevents corrosion is further formed thereon. The protection layer contains any one of silicon oxide, rare-earth oxide, aluminum nitride, and aluminum oxide as a main component, and the protection layer having such a material is formed to have a thickness falling within the range of 0.02 mm or above and 10 mm or less, thereby exponentially improving resistance properties against a corrosive gas. Furthermore, the protection layer can be prevented from being delaminated from the ceramic substrate due to thermal stress, whereby the long-lived corrosion-resistant multilayer ceramic member can be provided. For example, it is possible to provide the corrosion-resistant multilayer ceramic member that can be preferably used as a semiconductor wafer heating apparatus, e.g., a ceramic heater in a manufacturing process or an inspection process of a semiconductor device.

### BRIEF DESCRIPTION OF THE DRAWINGS

FIG. 1 is a view showing an example of a corrosion-resistant multilayer ceramic member according to the present invention;

FIG. 2 is a view showing another example of the corrosion-resistant multilayer ceramic member according to the present invention;

FIG. 3 is a view showing yet another example of the corrosion-resistant multilayer ceramic member according to the present invention; and

FIG. 4 is a view showing yet another example of the corrosion-resistant multilayer ceramic member according to the present invention.

### DETAILED DESCRIPTION OF THE PREFERRED EMBODIMENT

An embodiment according to the present invention will now be described hereinafter with reference to the drawings, but the present invention is not restricted thereto.

Here, FIG. 1 is a cross-sectional view showing an example of a corrosion-resistant multilayer ceramic member according to the present invention.

As shown in FIG. 1, in a corrosion-resistant multilayer ceramic member 1 according to the present invention, an electrode layer 3 is formed on one surface of a ceramic substrate 2, a feeding member 4 is connected with the electrode layer 3, and a protection layer 5 that contains any one of silicon oxide, rare-earth oxide, aluminum nitride, and aluminum oxide as a main component is formed with a thickness of 0.02 mm or above and 10 mm or less on the surface of the ceramic substrate 2 where the electrode layer 3 is formed so as to cover the electrode layer 3.

In the above-described corrosion-resistant multilayer ceramic member 1, for example, a heater electrode is formed as the electrode layer 3 as shown in FIG. 1. In this case, when a wafer 6 is mounted on the ceramic substrate 2 where the protection layer 5 is formed on the surface of the ceramic substrate 2 and the electrode layer 3 is formed so as to cover the electrode layer 3 and where the electrode layer 3 is not formed, and electricity is supplied from the feeding members 4 connected with the electrode layer 3, the wafer 6 mounted on the ceramic substrate 2 can be heated by electricity.

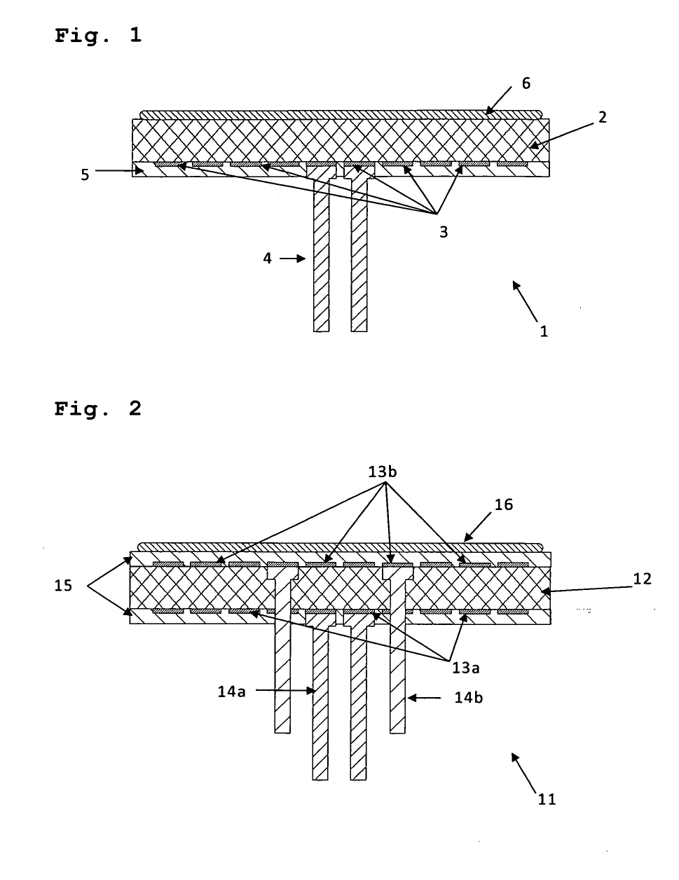

Further, FIG. 2 shows a cross-sectional view of another example of the corrosion-resistant multilayer ceramic member according to the present invention. As shown in FIG. 2, in a corrosion-resistant multilayer ceramic member 11 according to the present invention, an electrode layer 13a or 13b is formed on each of both surfaces of a ceramic substrate 12, a feeding member 14a is connected with the electrode layer 13a, a feeding member 14b is connected with the electrode layer 13b, and protection layers 15 that contain any one of silicon oxide, rare-earth oxide, aluminum nitride, and aluminum oxide as a main component are formed with a thickness of 0.02 mm or above and 10 mm or less on the surfaces of the ceramic substrate 12 where the electrode layers 13a and 13b are formed so as to cover the electrode layers 13a and 13b, respectively.

In the above-described corrosion-resistant multilayer ceramic member 11, for example, a heater electrode is formed as the electrode layer 13a and an electrostatic chuck electrode is formed as the electrode layer 13b as shown in FIG. 2. In this case, the protection layers 15 formed on the surfaces of the ceramic substrate 12 where the electrode layers 13a and 13b are formed so as to cover the electrode layers 13a and 13b, respectively, a wafer 16 is mounted on the protection layer on the side where the electrostatic chuck electrodes 13b are formed, and electricity is supplied from the feeding members 14a and 14b connected with the electrode layers 13a and 13b, respectively. As a result, the wafer 16 mounted on the protection layer 15 can be chucked and heated by electricity.

As explained above, the corrosion-resistant multilayer ceramic member according to the present invention is a corrosion-resistant multilayer ceramic member including at least a ceramic substrate, an electrode layer formed on the ceramic substrate, a feeding member that feeds electricity to the electrode layer, and a protection layer that prevents corrosion, wherein the electrode layer is formed on one surface or both surfaces of the ceramic substrate, the feeding member is connected with the electrode layer, the protection layer is formed with a thickness of 0.02 mm or above and 10 mm or less on the surface of the ceramic substrate where the electrode layer is formed so as to cover the electrode layer, and the protection layer contains at least one of silicon oxide, rare-earth oxide, aluminum nitride, and aluminum oxide as a main component.

As explained above, the protection layer in the corrosion-resistant multilayer ceramic member according to the present invention must contain any one of silicon oxide, rare-earth oxide, aluminum nitride, and aluminum oxide as a main component and must have a thickness of 0.02 mm or above and 10 mm or less. When the electrode layer formed on the ceramic substrate is covered with such a protection layer, corrosion of the electrode layer can be effectively prevented even when exposed to a corrosive gas, and delamination of the protection layer from the ceramic substrate due to thermal stress can be prevented. Thereby the corrosion-resistant multilayer ceramic member having a longer life duration is provided.

When the corrosion-resistant multilayer ceramic member having the above-described features is used for a ceramic heater, an electrostatic chuck, or a high-frequency electrode that is preferably utilized in, e.g., a semiconductor wafer heating process in a manufacturing process or an inspection process of a semiconductor device, this corrosion-resistant multilayer ceramic member can have excellent corrosion resistance and a long life duration with the electrode layer being hardly wasted even if exposed to a corrosive gas such as a chlorinated gas or a fluorinated gas as a deposition gas, an etching gas, or a cleaning gas.

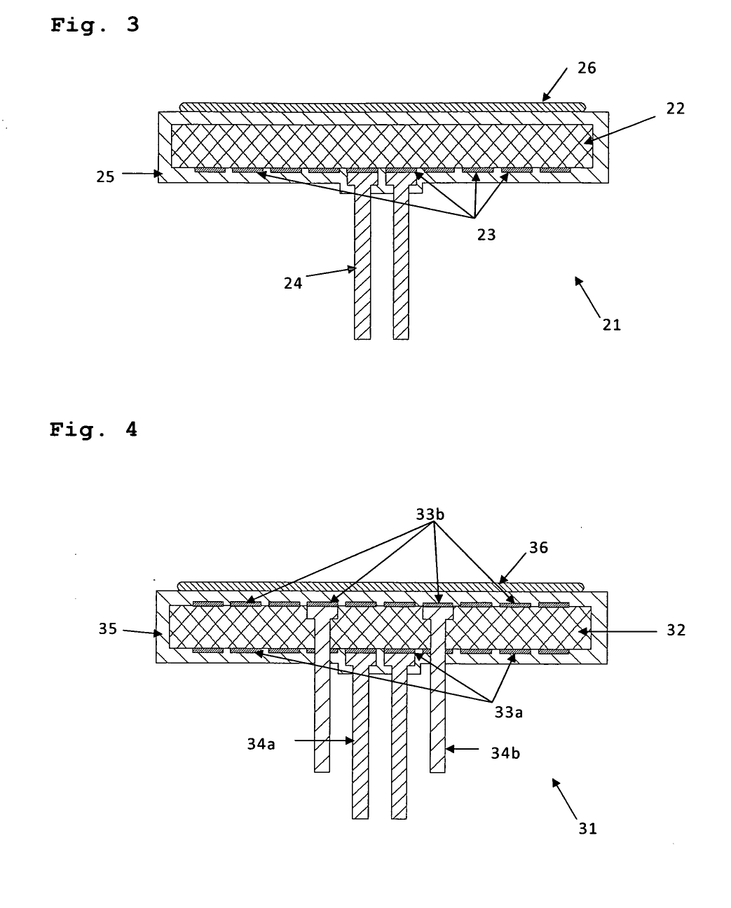

Furthermore, in the corrosion-resistant multilayer ceramic member according to the present invention, it is preferable that the protection layer formed on the surface of the ceramic substrate where the electrode layer is formed is formed to entirely enclose the connecting portion of the ceramic substrate and the electrode layer and that of the electrode layer and the feeding member. Each of FIGS. 3 and 4 is a cross-sectional view showing an example of a corrosion-resistant multilayer ceramic member according to the present invention having such a protection layer formed therein.

As shown in FIG. 3, in a corrosion-resistant multilayer ceramic member 21 according to the present invention, an electrode layer 23 is formed on one surface of a ceramic substrate 22, a feeding member 24 is connected with the electrode layer 23, and a protection layer 25 that contains any one of silicon oxide, rare-earth oxide, aluminum nitride, and aluminum oxide as a main component is formed with a thickness of 0.02 mm or above and 10 mm or less to entirely enclose a connecting portion of the ceramic substrate 22 and the electrode layer 23 and that of the electrode layer 23 and the feeding member 24.

In the above-described corrosion-resistant multilayer ceramic member 21, e.g., a heater electrode is formed as the electrode layer 23 as shown in FIG. 3. In this case, a wafer 26 is mounted on a side of the protection layer 25 where the electrode layer is not formed, the protection layer 25 being formed to entirely enclose the connecting portions of the ceramic substrate 22, the electrode layer 23, and the feeding member 24. Then, by supplying electricity from the feeding member 24 connected with the electrode layer 23, the wafer 26 mounted on the protection layer 25 can be heated by electricity.

Moreover, as shown in FIG. 4, in a corrosion-resistant multilayer ceramic member 31 according to the present invention, an electrode layer 33a or 33b is formed on each of both surfaces of a ceramic substrate 32, a feeding member 34a is connected with the electrode layer 33a, a feeding member 34b is connected with the electrode layer 33b, and a protection layer 35 containing any one of silicon oxide, rare-earth oxide, aluminum nitride, and aluminum oxide as a main component is formed with a thickness of 0.02 mm or above and 10 mm or less to entirely enclose a connecting portion of the ceramic substrate 32 and the electrode layers 33a and 33b and that of the electrode layers 33a and 33b and the feeding members 34a and 34b.

In the above-described corrosion-resistant multilayer ceramic member 31, e.g., a heater electrode is formed as the electrode layer 33a and an electrostatic chuck electrode is formed as the electrode layer 33b as shown in FIG. 4. In this case, a wafer 36 is mounted on the protection layer 35 formed to entirely enclose the connecting portion of the ceramic substrate 32 and the electrode layers 33a and 33b and that of the electrode layers 33a and 33b and the feeding members 34a and 34b, and electricity is supplied from the feeding members 34a and 34b connected with the electrode layers 33a and 33b. Then, the wafer 36 mounted on the protection layer 35 can be chucked and heated by electricity.

When the corrosion-resistant multilayer ceramic member having the above-described features is provided, since the protection layer containing any one of silicon oxide, rare-earth oxide, aluminum nitride, and aluminum oxide as a main component is formed with a thickness of 0.02 mm or above and 10 mm or less to entirely enclose the connecting portion of the ceramic substrate and the electrode layer and that of the electrode layer and the feeding member, entry of the above-described corrosive gas from the connecting part that is apt to be corroded can be prevented in particular when exposed to the corrosive gas, thereby providing the corrosion-resistant multilayer ceramic member having a longer life duration.

Additionally, it is preferable that the corrosion-resistant multilayer ceramic member according to the present invention is subjected to a heat treatment at a temperature of 1000° C. or above. When a heat treatment is carried out at a temperature of 1000° C. or above, contact of the protection layer and the electrode layer can be improved, the protection layer can be densified, and a life duration can be increased.

Further, it is preferable for the ceramic substrate to be formed of a material that contains any one of aluminum nitride, rare-earth oxide, aluminum oxide, silicon oxide, zirconia, and sialon as a main component. When the ceramic substrate is formed of such a material, the corrosion-resistant multilayer ceramic member having further excellent corrosion resistance can be provided.

Furthermore, it is preferable that the protection layer is formed by any technique selected from a screen printing method, a chemical vapor deposition method, and a plasma spraying method and the electrode layer is formed by any technique selected from the screen printing method, the chemical vapor deposition method, and a spraying method. The protection layer and the electrode layer formed by such techniques can have excellent uniformity. Moreover, since the protection layer and the electrode layer having excellent uniformity can be readily formed by such techniques, the corrosion-resistant multilayer ceramic member with a high yield ratio can be provided at a low cost.

### EXAMPLES

Heat treatment tests, examples, and comparative examples according to the present invention will now be specifically explained hereinafter, but the present invention is not restricted thereto.

### Example 1

A tungsten paste as a heater electrode was applied to one surface of a ceramic substrate which has an outer diameter of 300 mm and a thickness of 10 mm and is formed of aluminum nitride by a screen printing method, a tungsten electrode was baked in a nitrogen atmosphere at a high temperature of 1700° C. to form an electrode layer on the ceramic substrate, and a feeding member formed of tungsten was connected to the electrode layer. Moreover, a protection layer formed of yttrium oxide was laminated in the range of 0.02 mm or above and 10 mm or less by a spraying method so as to cover the electrode layer, thereby fabricating several types of corrosion-resistant multilayer ceramic members. A Si wafer was mounted on the ceramic substrate, electricity supplied from the feeding member, heating by electricity was performed to reach a wafer temperature of 800° C., and each member was exposed to a CF₄ plasma gas as a corrosive gas to carry out an endurance test.

### Comparative Example 1

Several types of corrosion-resistant multilayer ceramic members having the same structure as Example 1 except that a protection layer consisting of yttrium oxide is formed to fall within the range of 0.01 mm or above and less than 0.02 mm by the spraying method were fabricated, a Si wafer was mounted on a ceramic substrate, electricity supplied from a feeding member, heating by electricity was performed to reach a water temperature of 800° C., and each member was exposed to a CF₄ plasma gas as a corrosive gas to carry out an endurance test like Example 1.

As a result, in each ceramic member having the protection layer with a thickness of 0.02 mm or above and 10 mm or less (Example 1), stable heating by electricity was possible even if supplying electricity was continuously effected for 1000 hours. However, in each ceramic member having the protection layer with a thickness which is less than 0.02 mm (Comparative Example 1), a protection layer surface was corroded and corrosion reached the electrode layer when supplying electricity was performed for less than 1000 hours, and heating by electricity was impossible.

### Example 2

A tungsten paste as a heater electrode was applied to one surface of a ceramic substrate which has an outer diameter of 300 mm and a thickness of 10 mm and is formed of aluminum nitride by a screen printing method, a tungsten electrode was baked in a nitrogen atmosphere at a high temperature of 1700° C. to form an electrode layer on the ceramic substrate. Additionally, a protection layer formed of yttrium oxide was laminated in the range of 0.02 mm or above and 10 mm or less by a spraying method so as to cover an entire connecting portion of the ceramic substrate and the electrode layer and that of a feeding member formed of tungsten connected to the electrode layer and the electrode layer, thereby fabricating several types of corrosion-resistant multilayer ceramic members. A Si wafer was mounted on the ceramic substrate, electricity supplied from the feeding member, heating by electricity was performed to reach a wafer temperature of 800° C., and each member was exposed to a CF₄ plasma gas as a corrosive gas to carry out an endurance test.

### Comparative Example 2

Several types of corrosion-resistant multilayer ceramic members having the same structure as Example 2 except that a protection layer consisting of yttrium oxide is formed to fall within the range of 0.01 mm or above and less than 0.02 mm by the spraying method were fabricated, a Si wafer was mounted on a ceramic substrate, electricity supplied from a feeding member, heating by electricity was performed to reach a water temperature of 800° C., and each member was exposed to a CF₄ plasma gas as a corrosive gas to carry out an endurance test like Example 2.

As a result, in each ceramic member having the protection layer with a thickness of 0.02 mm or above and 10 mm or less (Example 2), stable heating by electricity was possible even if supplying electricity was continuously performed for 2000 hours. However, in each ceramic member having the protection layer with a thickness that is less than 0.02 mm (Comparative Example 2), a protection layer surface was corroded and corrosion reached the electrode layer when supplying electricity was performed for less than 1000 hours, and heating by electricity was impossible.

### Example 3

A tungsten paste as a heater electrode was applied to one surface of a ceramic substrate which has an outer diameter of 300 mm and a thickness of 10 mm and is formed of aluminum nitride by a screen printing method, a tungsten electrode was baked in a nitrogen atmosphere at a high temperature of 1700° C. to form an electrode layer on the ceramic substrate, and a feeding member formed of tungsten was connected with the electrode layer. Additionally, a protection layer formed of yttrium oxide was laminated in the range of 0.02 mm or above and 10 mm or less by a spraying method so as to cover the electrode layer, thereby fabricating several types of corrosion-resistant multilayer ceramic members. Thereafter, the corrosion-resistant multilayer ceramic member was subjected to a heat treatment at 1000° C. in a nitrogen atmosphere for 10 hours. A Si wafer was mounted on the ceramic substrate, electricity supplied from the feeding member, heating by electricity was performed to reach a wafer temperature of 800° C., and each member was exposed to a CF₄ plasma gas as a corrosive gas to carry out an endurance test.

### Comparative Example 3

Several types of corrosion-resistant multilayer ceramic members having the same structure as Example 3 except that a protection layer consisting of yttrium oxide is formed to fall within the range of 0.01 mm or above and less than 0.02 mm by the spraying method were fabricated, a Si wafer was mounted on a ceramic substrate, electricity supplied from a feeding member, heating by electricity was performed to reach a water temperature of 800° C., and each member was exposed to a CF₄ plasma gas as a corrosive gas to carry out an endurance test like Example 3.

As a result, in each ceramic member having the protection layer with a thickness of 0.02 mm or above and 10 mm or less (Example 3), stable heating by electricity was possible even if supplying electricity was continuously performed for 2000 hours. However, in each ceramic member having the protection layer with a thickness that is less than 0.02 mm (Comparative Example 3), a protection layer surface was corroded and corrosion reached the electrode layer when supplying electricity was performed for less than 1000 hours, and heating by electricity was impossible.

It is to be noted that the same result was obtained when a material of the protection layer was any one of silicon oxide, aluminum nitride, aluminum oxide, and any other rare-earth oxide in Examples and Comparative Examples mentioned above, and the same result was also obtained when a material of the ceramic substrate was a combination containing at least any one of rare-earth oxide, aluminum oxide, silicon oxide, zirconia, and sialon as a main component.

As described above, in the corrosion-resistant multilayer ceramic member according to the present invention, when the protection layer containing any one of silicon oxide, rare-earth oxide, aluminum nitride, and aluminum oxide as a main component is formed with a thickness of 0.02 mm or above and 10 mm or less so as to cover the electrode layer and others on the ceramic substrate, resistance properties against a corrosive gas can be greatly improved. Further, it was revealed that the protection layer can be prevented from being delaminated from the ceramic substrate and the long-lived corrosion-resistant multilayer ceramic member can be obtained.

What is claimed is:

1. A corrosion-resistant multilayer ceramic member comprising at least: a ceramic substrate, an electrode layer formed on the ceramic substrate, a feeding member that supplies electricity to the electrode layer, and a protection layer that prevents corrosion; wherein the electrode layer is formed on one surface or both surfaces of the ceramic substrate, the feeding member is connected with the electrode layer, the protection layer is formed with a thickness of 0.02 mm or above and 10 mm or less on that surface of the ceramic substrate where the electrode layer is formed so as to cover the electrode layer, and the protection layer contains any one of silicon oxide, rare-earth oxide, aluminum nitride, and aluminum oxide as a main component.

2. The corrosion-resistant multilayer ceramic member according to claim 1, wherein the protection layer formed on that surface of the ceramic substrate where the electrode layer is formed is formed to entirely enclose a connecting portion of the ceramic substrate and the electrode layer and that of the electrode layer and the feeding member.

3. The corrosion-resistant multilayer ceramic member according to claim 1, wherein the corrosion-resistant multilayer ceramic member is subjected to a heat treatment at a temperature of 1000° C. or above.

4. The corrosion-resistant multilayer ceramic member according to claim 2, wherein the corrosion-resistant multilayer ceramic member is subjected to a heat treatment at a temperature of 1000° C. or above.

5. The corrosion-resistant multilayer ceramic member according to claim 1, wherein the ceramic substrate is formed of a material including any one of aluminum nitride, rare-earth oxide, aluminum oxide, silicon oxide, zirconia, and sialon as a main component.

6. The corrosion-resistant multilayer ceramic member according to claim 2, wherein the ceramic substrate is formed of a material including any one of aluminum nitride, rare-earth oxide, aluminum oxide, silicon oxide, zirconia, and sialon as a main component.

7. The corrosion-resistant multilayer ceramic member according to claim 3, wherein the ceramic substrate is formed of a material including any one of aluminum nitride, rare-earth oxide, aluminum oxide, silicon oxide, zirconia, and sialon as a main component.

8. The corrosion-resistant multilayer ceramic member according to claim 4, wherein the ceramic substrate is formed of a material including any one of aluminum nitride, rare-earth oxide, aluminum oxide, silicon oxide, zirconia, and sialon as a main component.

9. The corrosion-resistant multilayer ceramic member according to claim 1, wherein the protection layer is formed by any technique selected from a screen printing method, a chemical vapor deposition method, and a plasma spraying method, and the electrode layer is formed by any technique selected from the screen printing method, the chemical vapor deposition method, and the spraying method.

10. The corrosion-resistant multilayer ceramic member according to claim 2, wherein the protection layer is formed by any technique selected from a screen printing method, a chemical vapor deposition method, and a plasma spraying method, and the electrode layer is formed by any technique selected from the screen printing method, the chemical vapor deposition method, and the spraying method.

11. The corrosion-resistant multilayer ceramic member according to claim 3, wherein the protection layer is formed by any technique selected from a screen printing method, a chemical vapor deposition method, and a plasma spraying method, and the electrode layer is formed by any technique selected from the screen printing method, the chemical vapor deposition method, and the spraying method.

12. The corrosion-resistant multilayer ceramic member according to claim 4, wherein the protection layer is formed by any technique selected from a screen printing method, a chemical vapor deposition method, and a plasma spraying method, and the electrode layer is formed by any technique selected from the screen printing method, the chemical vapor deposition method, and the spraying method.

13. The corrosion-resistant multilayer ceramic member according to claim 5, wherein the protection layer is formed by any technique selected from a screen printing method, a chemical vapor deposition method, and a plasma spraying method, and the electrode layer is formed by any technique selected from the screen printing method, the chemical vapor deposition method, and the spraying method.

14. The corrosion-resistant multilayer ceramic member according to claim 6, wherein the protection layer is formed by any technique selected from a screen printing method, a chemical vapor deposition method, and a plasma spraying method, and the electrode layer is formed by any technique selected from the screen printing method, the chemical vapor deposition method, and the spraying method.

15. The corrosion-resistant multilayer ceramic member according to claim 7, wherein the protection layer is formed by any technique selected from a screen printing method, a chemical vapor deposition method, and a plasma spraying method, and the electrode layer is formed by any technique selected from the screen printing method, the chemical vapor deposition method, and the spraying method.

16. The corrosion-resistant multilayer ceramic member according to claim 8, wherein the protection layer is formed by any technique selected from a screen printing method, a chemical vapor deposition method, and a plasma spraying method, and the electrode layer is formed by any technique selected from the screen printing method, the chemical vapor deposition method, and the spraying method.
